(19) United States
(12) Patent Application Publication
(10) Pub. No.: US 2011/0210179 A1
(43) Pub. Date: Sep. 1, 2011

(54) INTERNAL TRANSMISSION THERMOSTAT

(75) Inventors: George MOSER, Brighton, MI (US); Adam OSTAPOWICZ, Westland, MI (US)

(73) Assignee: EDC AUTOMOTIVE, LLC, Auburn Hills, MI (US)

(21) Appl. No.: 12/943,250

(22) Filed: Nov. 10, 2010

Related U.S. Application Data
(60) Provisional application No. 61/339,208, filed on Mar. 1, 2010.

(51) Int. Cl. F16H 57/04; G05D 23/08

(52) U.S. Cl. 236/93 R

(57) ABSTRACT

An internal thermostat for an automatic transmission of a motor vehicle includes a thermostat housing, a rotary valve and a bimetallic, temperature sensitive element. The thermostat housing is attached to an internal flow aperture of the transmission to be controlled. The rotary valve is moveable between an open position and a closed position in response to a temperature of oil, thereby controlling oil flow through the internal flow aperture of the transmission. The bimetallic temperature-sensitive element is attached to the rotary valve and operative to control an angular position of the valve as a function of the temperature of the surrounding oil. The bimetallic, temperature-sensitive element may be shaped like a coil. Alternatively, the bimetallic, temperature-sensitive element may be shaped like a substantially linear strip.

### CROSS-REFERENCE TO RELATED APPLICATIONS

This application claims the benefit of U.S. Provisional Application No. 61/339,208 filed on 1 Mar. 2010. The entire disclosure of the above application is incorporated herein by reference.

### FIELD

The present invention generally relates to an internal thermostat for the automatic transmission of a motor vehicle.

### BACKGROUND

The automatic transmission of a motor vehicle requires a certain level of automatic transmission fluid (ATF or transmission oil) for proper functioning. The proper level of ATF varies with the temperature. When the temperature is high, it is generally desirable to reduce the level of ATF to reduce the viscous resistance to the rotation of transmission parts (windage losses). The control of the ATF level can be achieved by providing two chambers in the transmission, which are connected by an orifice controlled by a thermostat. This device is often referred to as the transmission internal thermostat.

Traditionally, such a thermostat has been based on a wax actuator. However, there is concern at the automotive manufacturing companies that a wax actuator may not be able to survive the harsh environment inside the transmission including very high temperatures under certain conditions. A wax actuator can leak and fail. In addition, wax actuators in many cases have proven not to be able to provide the stroke and modulation characteristics desired by the automotive manufacturers. There is a need for a reliable, leak-free and cost-effective internal transmission thermostat.

### SUMMARY

Efforts have been made to use a wax element to control the flow of ATF. However, this approach has reliability issues, because the high temperature under which an oil thermostat operates makes it prone to failure. Even in more traditional uses, such as in water thermostats for engines, which typically operate at lower temperatures, the wax thermostat is a failure-prone component because of the tendency of the wax to leak out of the wax capsule. In an oil application the use of a wax motor is even riskier.

It is an object of present invention to provide a transmission thermostat that eliminates the wax element failure mode.

It is another object of present invention to provide a thermostat that is rugged and more reliable than conventional thermostats.

It is yet another object of present invention to provide a transmission oil thermostat with extreme longevity because of the very high cost of disassembling a transmission to replace the transmission thermostat.

In accordance with one particular application, the present teachings provide an internal thermostat for an automatic transmission of a motor vehicle. The internal thermostat includes a thermostat housing attached to an internal flow aperture of the transmission to be controlled. The internal thermostat additionally includes a rotary valve moveable between an open position and a closed position in response to a temperature of oil, thereby controlling oil flow through the internal flow aperture of the transmission. Further, the internal thermostat includes a bimetallic temperature-sensitive element shaped like a coil and attached to the rotary valve. The bimetallic temperature-sensitive element is operative to control an angular position of the valve as a function of the temperature of the surrounding oil.

In accordance with another particular application, the present teachings provide an internal thermostat for an automatic transmission of a motor vehicle including a thermostat housing, a rotary valve and a bimetallic, temperature sensitive element. The thermostat housing is attached to an internal flow aperture of the transmission to be controlled. The rotary valve is moveable between an open position and a closed position in response to a temperature of oil, thereby controlling oil flow through the internal flow aperture of the transmission. The bimetallic temperature-sensitive element is attached to the rotary valve and operative to control an angular position of the valve as a function of the temperature of the surrounding oil. The bimetallic, temperature-sensitive element is shaped like a substantially linear strip.

### DRAWINGS

FIG. 1 is a simplified, cross-sectional view of an internal transmission thermostat constructed in accordance with the present teachings, the thermostat shown with a valve rotated to a closed position.

FIG. 2 is a cross-sectional view similar to FIG. 1, the valve rotated to an open position.

FIG. 3 is a more detailed view of a portion of the internal transmission thermostat of FIG. 1, illustrating a bimetal coil for controlling the angular position of a rotary valve, the valve shown rotated to its closed position.

FIG. 4 is a side view of the portion of the internal transmission thermostat of FIG. 3.

FIG. 5 is another side view of the portion of the internal transmission thermostat of FIG. 3.

FIG. 6 is a cross-sectional view similar to FIG. 3, the valve shown rotated to its open position.

FIGS. 7-14 are cross-sectional views similar to FIG. 3, illustrating various variations of the internal transmission thermostat.

FIG. 15 is another cross-sectional view similar to FIG. 3 and illustrating another internal transmission thermostat design in accordance with the present teachings, the design being a non-balanced design, a valve rotated to a closed position.

FIG. 16 is a cross-sectional view similar to FIG. 15, the valve rotated to an open position.

FIG. 17 is another cross-sectional view similar to FIG. 3 and illustrating another internal transmission thermostat design in accordance with the present teachings, the design incorporating a linear bimetal element, a valve shown in a closed position.

FIG. 18 is a cross-sectional view similar to FIG. 17, the valve shown in an open position.

### DETAILED DESCRIPTION

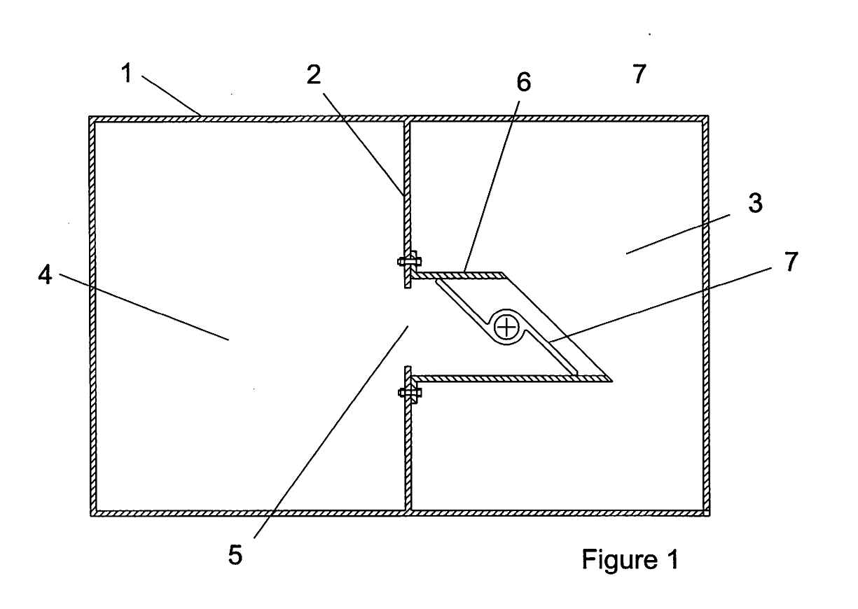

FIG. 1 shows the first embodiment of the present invention. The housing of the automatic transmission 1 contains two chambers, chamber 4 (which typically contains the sump) and chamber 3. The two chambers are separated by wall 2, which has an orifice 5 that communicates both chambers. However, the flow of oil through said orifice is controlled by thermostat 6, which is attached to dividing wall 2. The thermostat 6 contains an internal rotary valve 7 whose angular position determines whether the oil can flow through the thermostat or not. FIG. 1 shows the rotary valve in closed position, preventing the flow of oil between the chambers.

Some details are not shown in FIG. 1 for the sake of simplicity. For instance, chamber 3 is constantly being replenished with oil as part of the normal operation of the transmission. Further, there is a second orifice (not shown) in the dividing wall which prevents overfilling of chamber 5. Those details will be omitted in the Figures for the sake of clarity.

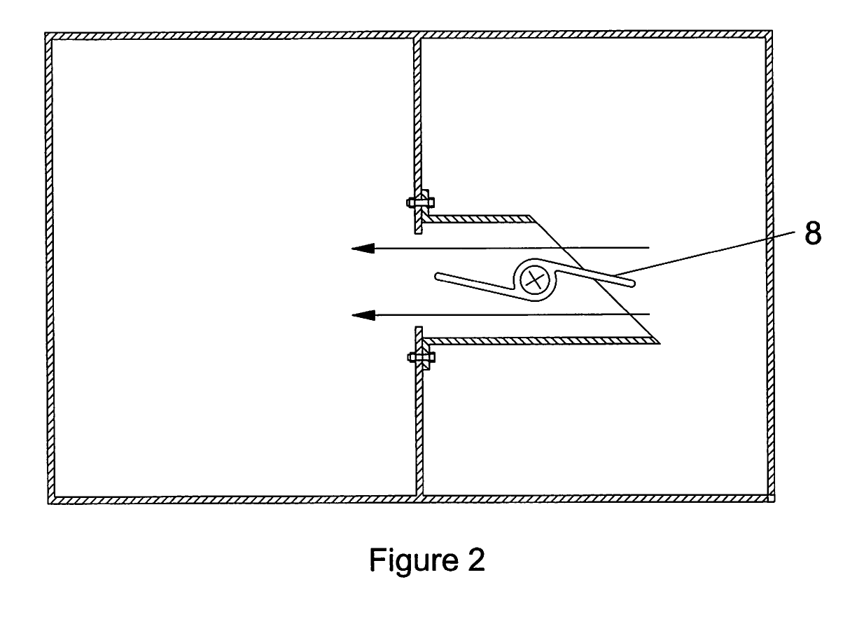

FIG. 2 shows the rotary valve 8 after having been rotated by a temperature-sensitive element (not shown in FIGS. 1 and 2) by a certain degree, thereby opening the thermostat and allowing the flow of oil from one chamber to the other (represented by the arrows).

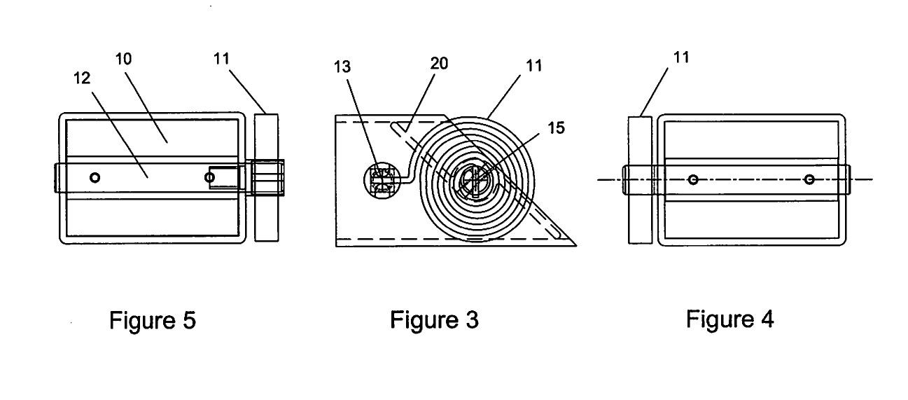

FIG. 3 shows that the angular position of the rotary valve 20 is controlled by the bimetal coil 11. A bimetal is typically a strip of metal that consists of two layers of different metals which have been molecularly bonded to each other through processes involving high pressure and sometimes also high temperatures. Since the two metallic layers have different coefficients of expansion, a change of temperature causes the bimetal to curve. If the bimetal strip has been formed into a coil, the response to a change in temperature is a predictable, repetitive and consistent rotation of one end of the coil with respect to the other end. In FIG. 3, one end of the bimetal coil 11 is attached to a fixed point in the thermostat housing 13, while the other end is attached to the hub of the rotary valve 20. Therefore a change in temperature of the oil that surrounds the coil will result in a rotation of the valve 20 by a predictable angle.

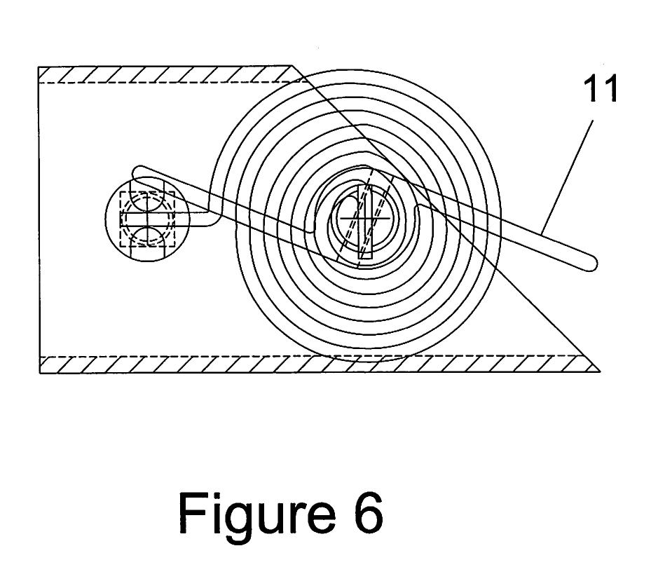

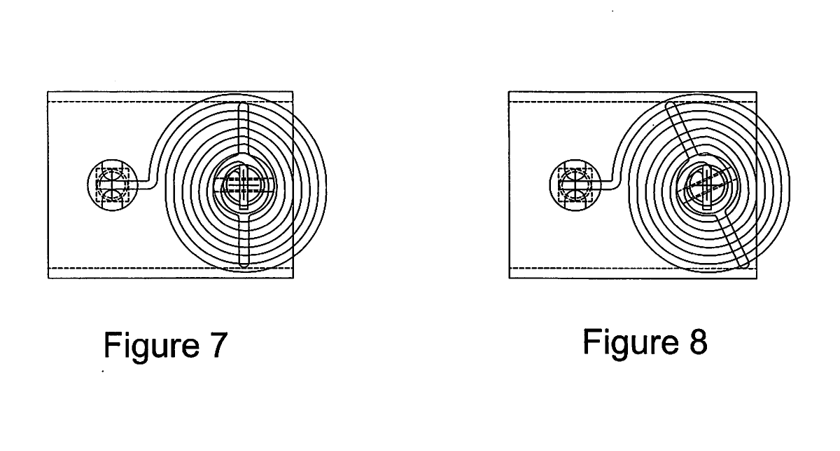

FIGS. 4 and 5 show both side views of the thermostat of this invention. Notice that 11 represents the bimetal coil that controls the rotation of the thermostat.

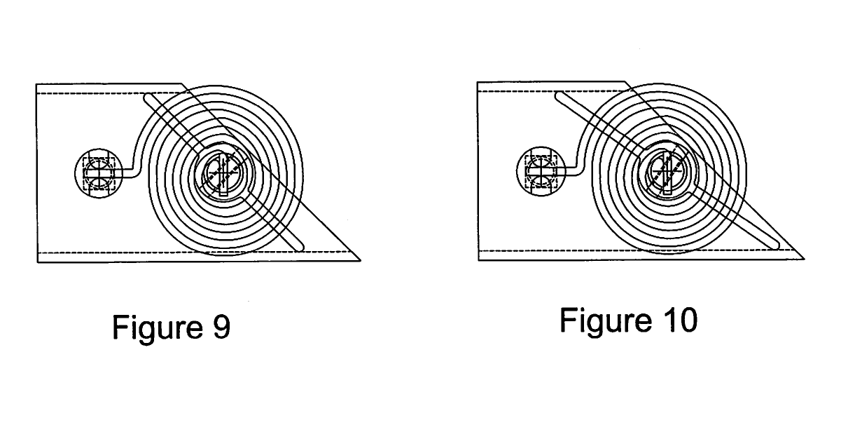

FIG. 6 shows the previously described thermostat in an open position.

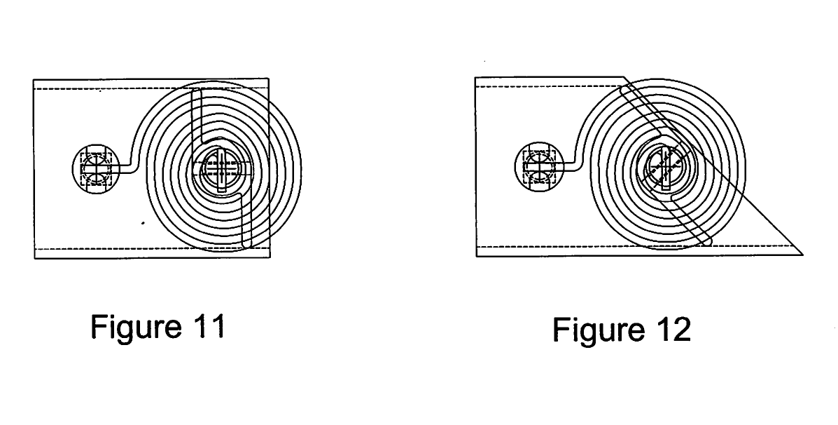

FIGS. 7 through 14 show different variations of the previously described thermostat. They are intended to accommodate different types of coils and different temperature ranges of operation of the transmission oil.

Notice that all of configurations shown until now (FIGS. 1 through 14) are based on a balanced design, wherein the hub of the rotary valve 11 is centered with respect to the oil flow. As a result of this type of design, the rotary valve is relatively pressure-insensitive, because one half of the valve is exposed to oil pressure exerting a torque in one direction, while the other half of the valve is exposed to pressure exerting a torque in the opposite direction. The result is a zero or negligible net torque. This is a valuable feature of this invention, because it prevents the valve from getting stuck under heavy pressure conditions.

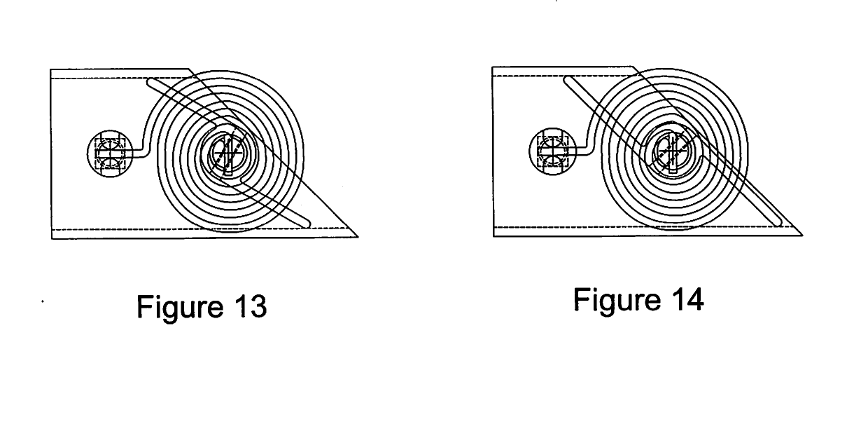

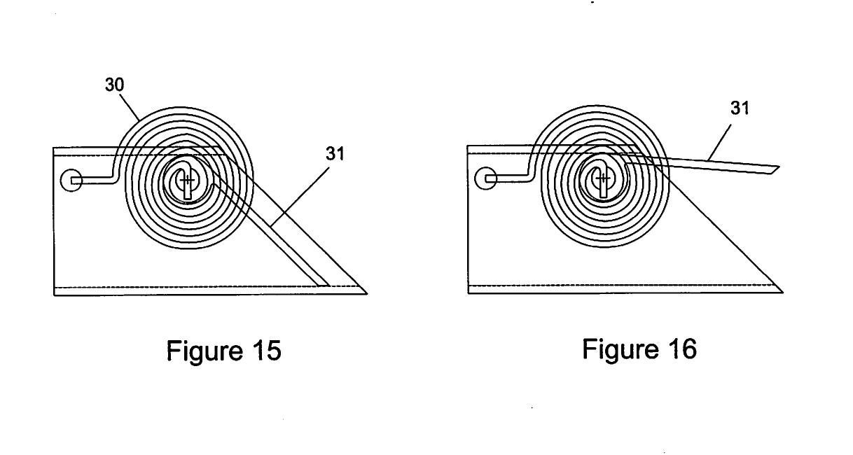

FIG. 15 shows a transmission thermostat based on a non-balanced design. The hub of the rotary valve 31 is located near the top of the thermostat housing (instead of being centered on it as shown in the previous embodiments). FIG. 16 shows the same embodiment in open position. The advantage of the embodiment shown in FIGS. 15 and 16 is that the rotary valve opens a bigger opening when rotated by the bimetal coil 30, because the hub is located out of the way and does not partially impede the flow of oil through the thermostat. That makes this embodiment desirable for thermostat that need to accommodate a high flow. The disadvantage is that this design can be pressure-sensitive and may stick under high pressure conditions. That can be compensated to some extent by using a thicker, stronger bimetal coil, but that has an impact on cost (and potentially on maximum coil stroke as well). This embodiment is suitable only for certain applications (for instance, high flow, low pressure applications).

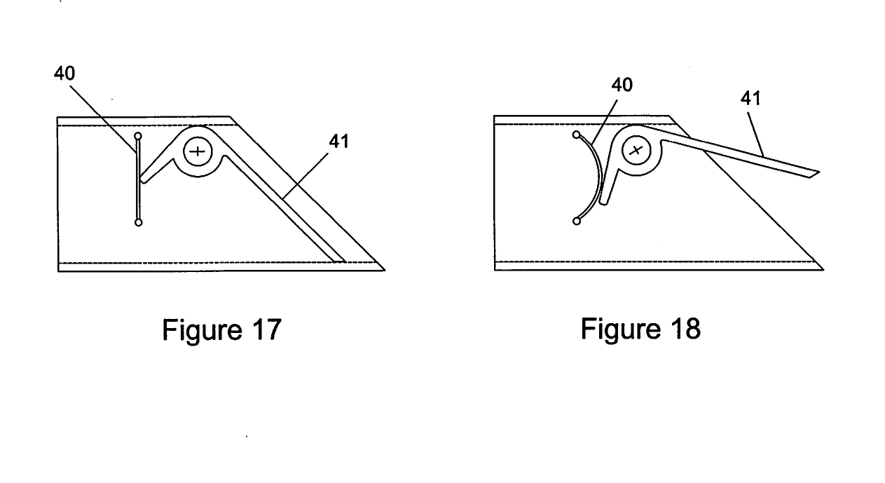

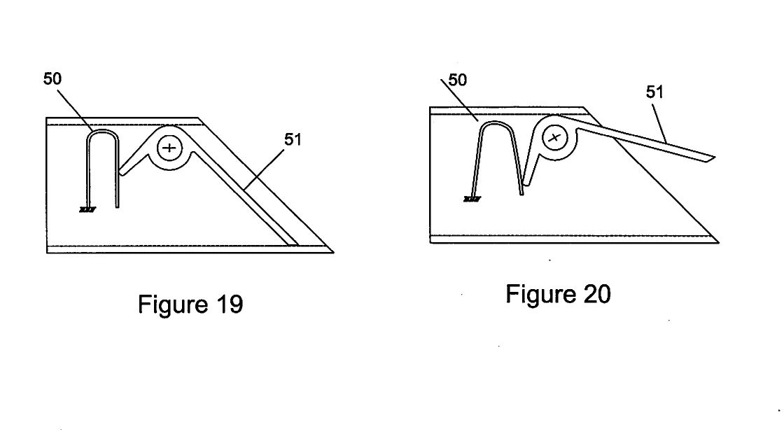

All embodiments shown until now (FIGS. 1 through 16) are based on rotary bimetal elements. FIGS. 17 and 18 show that a linear bimetal can be used too. In FIG. 17, the linear bimetal 40 is attached to the housing on both ends. Its center point rests against the body of the rotary valve. FIG. 17 shows that when the temperature changes, the linear bimetal strip takes on a curved shape and causes the rotary valve 41 to rotate and open the thermostat. This embodiment can be used both with a non-balanced design (as shown in FIGS. 17 and 18), or alternatively with a balanced design (not shown). The advantage of a linear bimetal strip (as opposed to a bimetal strip) is the lower cost, but the disadvantage is that typically the total stroke that can be achieved is smaller than a coil. Therefore that approach is suited only for thermostats that require only a relatively small stroke.

FIGS. 19 and 20 show another embodiment wherein the linear strip has been bent to increase its total length and provide a larger stroke (the total stroke is proportional to the total length of the bimetal element).

FIG. 19 is another cross-sectional view similar to FIG. 3 and illustrating another internal transmission thermostat in accordance with the present teachings. The design incorporating a linear bimetal element, the linear strip shown bent to increase its total length and provide a longer stroke, a valve shown in a closed position.

FIG. 20 is a cross-sectional view similar to FIG. 19, the valve shown in an open position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An internal thermostat for an automatic transmission of a motor vehicle, the internal thermostat comprising:
a thermostat housing attached to an internal flow aperture of the transmission to be controlled;
a rotary valve moveable between an open position and a closed position in response to a temperature of oil, thereby controlling oil flow through the internal flow aperture of the transmission; and
a bimetallic temperature-sensitive element shaped like a coil and attached to the rotary valve, the bimetallic temperature-sensitive element operative to control an angular position of the valve as a function of the temperature of the surrounding oil.

2. The internal transmission thermostat of claim 1, wherein the rotary valve is placed in a substantially balanced arrangement in the oil flow, so that the symmetry of the pressure loads on the valve cancels out the opposite torques induced on the valve, thereby rendering the valve non-pressure sensitive and avoiding the potential risk of the valve sticking under a high pressure situation.

3. The internal transmission thermostat of claim 1, wherein the rotary valve is placed in a non-balanced arrangement in the oil flow, in order to maximize the valve opening and achieve a high flow through the valve.

4. The internal transmission thermostat of claim 1, in combination with the automatic transmission.

5. An internal thermostat for an automatic transmission of a motor vehicle, the internal thermostat comprising:
a thermostat housing attached to an internal flow aperture of the transmission to be controlled;
a rotary valve moveable between an open position an a closed position in response to the temperature of oil, thereby controlling oil flow through the internal flow aperture of the transmission; and
a bimetallic temperature-sensitive element shaped like a substantially linear strip that is in contact with the rotary valve and controls an angular position of the valve as a function of the temperature of the surrounding oil.

6. The internal transmission thermostat of claim 5, wherein the rotary valve is placed in a substantially balanced arrangement in the oil flow, so that the symmetry of the pressure loads on the valve cancels out the opposite torques induced on the valve, thereby rendering the valve non-pressure sensitive and avoiding the potential risk of the valve sticking under a high pressure situation.

7. The internal transmission thermostat of claim 5, wherein the rotary valve is placed in a non-balanced arrangement in the oil flow, in order to maximize the valve opening and achieve a high flow through the valve.

8. The internal transmission thermostat of claim 5, wherein the substantially linear bimetal element is bent or shaped in form of one or more convolutions in order to increase its total length and therefore increase the stroke of the valve.

9. The internal transmission thermostat of claim 5, in combination with the automatic transmission.
